(19) United States
(12) Patent Application Publication
(10) Pub. No.: US 2004/0228484 A1
(43) Pub. Date: Nov. 18, 2004

(54) Public key generation apparatus, shared key generation apparatus, key exchange apparatus, and key exchanging method

(76) Inventor: Ryogo Yanagisawa, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/809,507

(22) Filed: Mar. 26, 2004

(30) Foreign Application Priority Data
Mar. 27, 2003 (JP) 2003-088788

(51) Int. Cl. H04L 9/00

(52) U.S. Cl. 380/44

(57) ABSTRACT

A shared key generation apparatus is formed by integrating a random number generator for generating a random number ka that holds a relationship 0<ka<q where an element in a finite group F for which multiplication is defined is g and an order as a prime number of the element g is q; a public key generator for calculating a public key ya in the finite group F using the random number ka, the element g, and the prime number q; and a shared key generator for generating a shared key Ka on the basis of a public key yb generated by a user 2 (public key distribution source and public key distribution destination) and the secret key ka generated by the random number generator, on one LSI, thereby preventing main arithmetic of the shared key generation apparatus from being revealed.

### FIELD OF THE INVENTION

The present invention relates to public key generation apparatuses, shared key generation apparatuses, key exchange apparatuses, and key exchange methods, which are utilized to safely perform transmission of electronic information in an open network with being hidden from third parties and, more particularly, to a public key generation apparatus, a shared key generation apparatus, a key exchange apparatus, and a key exchange method, wherein it is extremely difficult for the third parties to divert or change the device or an arithmetic thereof.

### BACKGROUND OF THE INVENTION

A Diffie-Hellman key exchange apparatus (hereinafter, referred to as a DH key exchange apparatus) is known as a key exchange apparatus that utilizes a conventional discrete logarithm problem in a finite group. (For example, see Japanese Published Patent Application No. 2001-352319, page.4, FIG. 4).

FIG. 5 shows a prior art of the DH key exchange apparatus. In FIG. 5, reference numeral 51 denotes a random number generation means for user 1 that is a source of public key distribution. Numeral 52 denotes a public key generation means for user 1. Numeral 53 denotes a shared key generation means for user 1. Further, numeral 54 denotes a random number generation means for user 2, numeral 55 denotes a public key generation means for user 2 that is a destination of public key distribution, and numeral 56 denotes a shared key generation means for user 2.

Hereinafter, a method in which the user 1 and the user 2 share a key using a conventional DH key exchange apparatus for user 1 and a conventional DH key exchange apparatus for user 2 will be described with reference to FIG. 5.

It is assumed here that multiplication is defined for a finite group F. An element in the finite group F is referred to as g (g has an order q that is a prime number). The finite group F, the element g, and the prime number q are open to the public, and are shared by at least the user 1 and the user 2. The user 1 and the user 2 share the key by following steps.

(Step 1)

The user 1 generates a random number ka (0<ka<q) using the random number generation means 51, and employs the generated random number as a secret key ka for the user 1. Similarly, the user 2 generates a random number kb (0<kb<q) using the random number generation means 54, and employs the generated random number as a secret key kb for the user 2.

(Step 2)

The user 1 generates a public key ya using the public key generation means 52. In this case,

ya=g\hat{ }ka mod q Formula 1

and ya is calculated in the finite group F. Here, “mod q” represents the remainder of division by q. That is, the public key ya is the remainder that is obtained by dividing the ka-th power of g by q. Similarly, the user 2 generates a public key yb using the public key generation means 55. In this case,

yb=g\hat{ }kb mod q Formula 2

and yb is calculated in the finite group F.

(Step 3)

The user 1 transmits the public key ya to the user 2, and the user 2 transmits the public key yb to the user 1. In other words, the user 1 and the user 2 exchange the public key ya and the public key yb.

(Step 4)

The user 1 generates a key Ka using the shared key generation means 53. In this case,

$$\begin{matrix}Ka = yb \hat{} ka m o d q \\ = g \hat{} ( ka \times kb ) mod q\end{matrix} \qquad Formula 3$$

and Ka is calculated in the finite group F. Similarly, the user 2 generates a key Kb using the shared key generation means 56. In this case,

$$\begin{matrix}Kb = ya \hat{} kb m o d q \\ = g \hat{} ( ka \times kb ) mod q\end{matrix} \qquad Formula 4$$

and Kb is calculated in the finite group F.

From the above-mentioned steps 1 to 4, the same shared key K=Ka=Kb is generated by the user 1 and the user 2.

The above-mentioned DH key exchange apparatus is constructed based on the difficulty in solving the discrete logarithm problem in the finite group F. That is, when the prime number q and the element g are given, y=g\hat{ }x mod q (0<x<q) is easily calculated from an integer x, while it is difficult to obtain an integer x that holds a relationship: y=g\hat{ }x mod q (0<x<q), which is considered to constitute grounds for the safety.

An elliptic curve cryptosystem is widely known as a cryptosystem based on the difficulty in solving the discrete logarithm problem in the finite group F. More specifically, when assuming an elliptic curve in the finite group as E(F), a point on the elliptic curve E(F) which is previously shared by the user 1 and the user 2 as G, and an arithmetic xG using a point x on the elliptic curve E(F) is defined, the formulas (1) to (4) can be converted into formulas (5) to (8).

ya=kaG mod q Formula 5

yb=kbG mod q Formula 6

$$\begin{matrix}\begin{matrix}Ka = ka ( yb ) mod q \\ = kakbG mod q\end{matrix} & Formula 7 \\ \begin{matrix}Kb = kb ( ya ) mod q \\ = kakbG mod q\end{matrix} & Formula 8\end{matrix}$$

As described above, the user 1 and the user 2 generate the same shared key K=Ka=Kb also by utilizing the elliptic curve cryptosystem. It is known that, when selecting a prime number q comprising about 160 bits, the solution cannot be obtained in a practical time even when the most efficient computational algorithm among those that are presently known and the latest computer are used.

As described above, in the DH key exchange apparatus, g\hat{ }x (i.e., xG in the elliptic curve cryptosystem) is a main arithmetic operation at the key exchange. Usually, the secret key x is set at the bit length that is approximately equal to the prime number q (approximately 160 bits in the elliptic curve cryptosystem). However, if malicious third parties other than the users 1 and 2 divert g\hat{ }x (or xG) or make the length of the secret key longer, a more solid public key cryptosystem can be easily constructed. Therefore, the conventional structure as shown in FIG. 5 is not preferable from a safety standpoint of the cryptosystem. Particularly when a high-speed computational algorithm is used in the main arithmetic, damages would be more serious.

As the conventional key exchange apparatus and method utilize the DH key exchange apparatus that takes no measures against attacks by the third parties, in case the malicious third parties may divert or change the key exchange apparatus or main arithmetic expression of this apparatus, the key exchange apparatus becomes inoperative, which leads to quite serious damages to the national security.

### SUMMARY OF THE INVENTION

The present invention has for its object to provide a public key generation apparatus, a shared key generation apparatus, a key exchange apparatus, and a key exchange method, to which diversion or change of a main arithmetic by the third parties is extremely hard to perform.

Other objects and advantages of the invention will become apparent from the detailed description that follows. The detailed description and specific embodiments described are provided only for illustration since various additions and modifications within the spirit and scope of the invention will be apparent to those of skill in the art from the detailed description.

According to a 1st aspect of the present invention, there is provided a public key generation apparatus including: a random number generator for generating a random number ka that holds a relationship 0<ka<q, where an element in a finite group F for which multiplication is defined is g and an order that is a prime number of the element g is q; and a public key generator for calculating a public key ya in the finite group F from the random number ka, the element g, and the prime number q, at least the random number generator and the public key generator being formed on one semiconductor integrated circuit, and a controller of a first user as a distribution source of the public key controlling the random number generator and the public key generator for obtaining the public key ya, and transmitting the obtained public key ya to a second user as a distribution destination of the public key. Therefore, the secret key ka is used in a chip of the semiconductor integrated circuit only for the generation of the public key ya. Accordingly, the arithmetic of the key exchange apparatus is not revealed to the outside. By utilizing this integrated circuit, it becomes quite difficult to divert or change the public key generation apparatus for purposes other than the generation of the public key ya, whereby resistance to illegal attacks by the third parties becomes extremely high.

According to a 2nd aspect of the present invention, in the public key generation apparatus of the 1st aspect, the public key generator calculates the public key ya in the finite group F by a formula: ya=g\hat{ }ka mod q, using the random number ka, the element g, and the prime number q. Therefore, it becomes quite difficult to divert or change the public key generation apparatus for purposes other than the generation of the public key ya in a cryptosystem based on the difficulty in solving the discrete logarithm problem in the finite group F, whereby the resistance to illegal attacks by the third parties becomes quite high.

According to a 3rd aspect of the present invention, in the public key generation apparatus of the 1st aspect, when the finite group F is an elliptic curve E(F) in a finite field, and an element of the elliptic curve E(F) is G, the public key generator calculates the public key ya on the elliptic curve E(F) by a formula: ya=kaG mod q, using the random number ka, the element G, and the prime number q. Therefore, also in the elliptic curve cryptosystem, it is possible to achieve a state where the diversion or change of the public key generation apparatus for purposes other than the generation of the public key ya is quite difficult, whereby the resistance to illegal attacks by the third parties becomes extremely high.

According to a 4th aspect of the present invention, in the public key generation apparatus of any of the 1st to 3rd aspects, the random number generator generates a new random number ka after the calculation of the public key ya is completed. Therefore, each time the public key ya is outputted, it has a different value, whereby the resistance to illegal attacks by the third parties becomes higher.

According to a 5th aspect of the present invention, there is provided a shared key generation apparatus including: a random number generator for generating a random number ka that holds a relationship 0<ka<q, where an element in a finite group F for which multiplication is defined is g and an order that is a prime number of the element g is q; and a shared key generator for calculating a shared key Ka in the finite group F from a public key yb that is generated from a random number kb which holds a relationship 0<kb<q and is generated by a second user as a distribution destination of the shared key, and the random number ka, at least the random number generator and the shared key generator being formed on one semiconductor integrated circuit, and a controller of a first user as a distribution source of the shared key obtaining the public key yb from the second user as the shared key distribution destination, and controlling the random number generator and the shared key generator for deriving the shared key Ka. Therefore, the secret key ka is used in a chip of the semiconductor integrated circuit only for the generation of the shared key Ka, whereby the arithmetic of the key exchange apparatus is not revealed to the outside. By utilizing this integrated circuit, it becomes quite difficult to divert or change the shared key generation apparatus for purposes other than the generation of the shared key Ka, whereby the resistance to illegal attacks by the third parties becomes extremely high.

According to a 6th aspect of the present invention, in the shared key generation apparatus of the 5th aspect, the shared key generator calculate the shared key Ka in the finite group F by a formula: Ka=yb\hat{ }ka mod q, using the public key yb=g\hat{ }kb mod q which is generated by the second user as the shared key distribution destination and the random number ka. Therefore, in a cryptosystem based on the difficulty in solving the discrete logarithm problem in a finite group F, it is possible to achieve a state where the diversion or change of the shared key generation apparatus for purposes other than the generation of the shared key Ka is quite difficult, whereby the resistance to illegal attacks by the third parties becomes extremely high.

According to a 7th aspect of the present invention, in the shared key generation apparatus of the 5th aspect, when the finite group F is an elliptic curve E(F) in a finite field and an element of the elliptic curve E(F) is G, the shared key generator calculates the shared key Ka on the elliptic curve E(F) by a formula: Ka=kayb mod q, using the public key yb=kbG mod q which is generated on the elliptic curve E(F) from the random number kb by the second user as the shared key distribution destination, and the random number ka. Therefore, also in an elliptic curve cryptosystem, it is possible to achieve a state where the diversion or change of the shared key generation apparatus for purposes other than the generation of the shared key Ka is quite difficult, whereby the resistance to illegal attacks by the third parties becomes extremely high.

According to an 8th aspect of the present invention, in the shared key generation apparatus of any of the 5th to 7th aspects, the random number generator generates a new random number ka after the calculation of the shared key Ka is completed. Therefore, each time the shared key Ka is outputted, it has a different value, whereby the resistance to illegal attacks by the third parties becomes higher.

According to a 9th aspect of the present invention, there is provided a key exchange apparatus including: a random number generator for generating a random number ka that holds a relationship 0<ka<q, where an element in a finite group F for which multiplication is defined is g and an order that is a prime number of the element g is q; a public key generator for calculating a public key ya in the finite group F from the random number ka, the element g, and the prime number q; and a shared key generator for calculating a shared key Ka in the finite group F on the basis of the public key yb generated from a random number kb which holds a relationship 0<kb<q and is generated by a second user as a distribution destination of the shared key, and the random number ka, at least the random number generator, the public key generator, and the shared key generator being formed on one semiconductor integrated circuit, and a controller of a first user as a distribution source of the shared key controlling the random number generator and the public key generator for obtaining the public key yb, and controlling the shared key generation unit for deriving the shared key ka. Therefore, the secret key ka is used in a chip of the semiconductor integrated circuit only for the generation of the public key ya and the shared key Ka, whereby the arithmetic of the key exchange apparatus is not revealed to the outside. By utilizing this integrated circuit, it becomes quite difficult to divert or change the key exchange apparatus for cryptography other than key exchange, whereby the resistance to illegal attacks by the third parties becomes extremely high.

According to a 10th aspect of the present invention, in the key exchange apparatus of the 9th aspect, the public key generator calculates the public key ya in the finite group F by a formula: ya=g\hat{ }ka mod q, using the random number ka, the element g, and the prime number q, and the shared key generator calculates the shared key Ka in the finite group F by a formula: Ka=yb\hat{ }ka mod q, using the public key yb=g\hat{ }kb mod q which is generated in the finite group F by the second user as the shared key distribution destination using the random number kb, and the random number ka. Therefore, in a cryptosystem based on the difficulty in solving the discrete logarithm problem in the finite group F, it is possible to achieve a state where the diversion or change of the key exchange apparatus for cryptography other than key exchange is quite difficult, whereby the resistance to illegal attacks by the third parties becomes extremely high.

According to an 11th aspect of the present invention, in the key exchange apparatus of the 9th aspect, when the finite group F is an elliptic curve E(F) in a finite field, and an element of the elliptic curve E(F) is G, the public key generator calculates the public key ya on the elliptic curve E(F) by a formula: ya=kaG mod q, using the random number ka, the element G, and the prime number q, and the shared key generator calculates the shared key Ka on the elliptic curve E(F) by a formula: Ka=kayb mod q, using the public key yb=kbG mod q generated from the random number kb on the elliptic curve E(F) by the second user as the shared key distribution destination, and the random number ka. Therefore, also in an elliptic curve cryptosystem, it is possible to achieve a state where the diversion or change of the key exchange apparatus for cryptography other than the key exchange is quite difficult, whereby the resistance to illegal attacks by the third parties becomes extremely high.

According to a 12th aspect of the present invention, in the key exchange apparatus of any of the 9th to 11th aspects, the random number generator generates a new random number ka after the calculation of the public key ya and the calculation of the shared key Ka are both completed. Therefore, each time the public key ya and the shared key Ka are outputted, they have different values, whereby the resistance to illegal attacks by the third parties becomes higher.

According to a 13th aspect of the present invention, there is provided a key exchange apparatus including: a random number generator for generating a random number ka that holds a relationship 0<ka<q, where an element in a finite group F for which multiplication is defined is g and an order that is a prime number of the element g is q; a secret key holding unit for temporarily holding the random number ka; a public key generator for calculating a public key ya in the finite group F from the random number ka, the element g, and the prime number q; and a shared key generator for calculating a shared key Ka in the finite group F using a public key yb generated from a random number kb which holds a relationship 0<kb<q and is generated by a second user as a destination distribution of the shared key, and the random number ka that is held by the secret key holding unit, at least the random number generator, the secret key holding unit, the public key generator, and the shared key generator being formed on one semiconductor integrated circuit, a controller of a first user as a distribution source of the shared key controlling the random number generator and the public key generator for obtaining the public key ya, and transmitting the obtained public key ya to a second user as a distribution destination of the shared key, and the controller obtaining the public key yb from the second user as the shared key distribution destination, and controlling the shared key generator for deriving the shared key Ka. Therefore, the secret key ka is used in a chip of the semiconductor integrated circuit only for the generation of the public key ya and the shared key Ka, whereby the arithmetic of the key exchange apparatus is not revealed to the outside. By utilizing this integrated circuit, it becomes quite difficult to divert or change the key exchange apparatus for cryptography other than key exchange, whereby the resistance to illegal attacks by the third parties becomes extremely high. In addition, even when the random number generator generates a new random number before the shared key generator generates the shared key Ka, the shared key generator can generate the shared key Ka properly.

According to a 14th aspect of the present invention, in the key exchange apparatus of the 13th aspect, the public key generator calculates the public key ya in the finite group F using the random number ka, the element g, and the prime number q by a formula: ya=g\hat{ }ka mod q, and the shared key generator calculates the shared key Ka in the finite group F by a formula: Ka=yb\hat{ }ka mod q, using the public key yb=g\hat{ }kb mod q that is generated in the finite group F from the random number kb by the second user as the shared key distribution destination, and the random number ka that is held in the secret key holding unit. Therefore, in a cryptosystem based on the difficulty in solving the discrete logarithm problem in the finite group F, it is possible to achieve a state where the diversion or change of the key exchange apparatus for cryptography other than the key exchange is quite difficult, whereby the resistance to illegal attacks by the third parties becomes extremely high.

According to a 15th aspect of the present invention, in the key exchange apparatus of the 13th aspect, when the finite group F is an elliptic curve E(F) in a finite field, and an element on the elliptic curve E(F) is G, the public key generator calculates the public key ya on the elliptic curve E(F) using the random number ka, the element G, and the prime number q by a formula: ya=kaG mod q, and the shared key generator calculates the shared key Ka on the elliptic curve E(F) by a formula: Ka=Kayb mod q, using the public key yb=kbG mod q that is generated from the random number kb on the elliptic curve E(F) by the second user as the shared key distribution destination, and the random number ka that is held in the secret key holding unit. Therefore, also in an elliptic curve cryptosystem, it is possible to achieve a state where the diversion or change of the key exchange apparatus for cryptography other than the key exchange is quite difficult, whereby the resistance to illegal attacks by the third parties becomes extremely high.

According to a 16th aspect of the present invention, in the key exchange apparatus of any of the 13th to 15th aspects, the random number generator generates a new random number ka after the calculation of the public key ya is completed, and the secret key holding unit holds the new random number ka generated by the random number generator. Therefore, each time the public key ya and the shared key Ka are outputted, they have different values, whereby the resistance to illegal attacks by the third parties becomes higher.

According to a 17th aspect of the present invention, in the key exchange apparatus of any of the 13th to 15th aspects, the random number generator generates a new random number ka after the calculation of the shared key Ka is completed, and the secret key holding unit holds the new random number ka generated by the random number generator. Therefore, even when the random number generator generates a new random number before the shared key generator generates a shared key Ka, the shared key generator can generate the shared key Ka properly.

According to an 18th aspect of the present invention, there is provided a key exchanging method that employs the key exchange apparatus of any of the 9th to 17th aspect, thereby exchanging the public keys that are generated by a first user and a second user that intend to exchange the public keys, respectively, to generate a shared key by the first user and the second user on the basis of the exchanged public key, respectively. Therefore, the arithmetic of key exchange apparatus is not revealed to the outside. By utilizing such integrated circuit, it becomes quite difficult to divert or change the apparatus for cryptography other than generation of a cryptograph key or key exchange, whereby the resistance to illegal attacks by the third parties becomes extremely high.

### BRIEF DESCRIPTION OF THE DRAWINGS

FIG. 1 is a block diagram illustrating a structure of a public key generation apparatus according to a first embodiment of the present invention.

FIG. 2 is a block diagram illustrating a structure of a shared key generation apparatus according to a second embodiment of the present invention.

FIG. 3 is a block diagram illustrating a structure of a key exchange apparatus according to a third embodiment of the present invention.

FIG. 4 is a block diagram illustrating a structure of a key exchange apparatus according to a fourth embodiment of the present invention.

FIG. 5 is a block diagram illustrating a structure of a conventional key exchange apparatus.

### DETAILED DESCRIPTION OF THE PREFERRED EMBODIMENTS

Hereinafter, embodiments of the present invention will be described with reference to the drawings.

### Embodiment 1

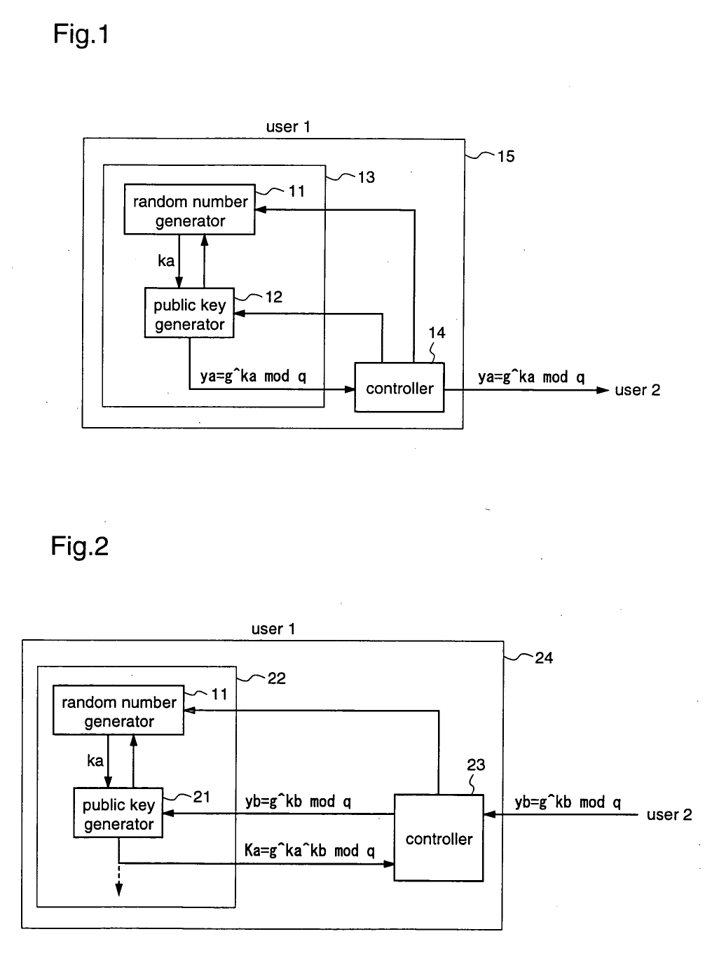

FIG. 1 is a block diagram illustrating a structure of a public key generation apparatus according to a first embodiment, corresponding to claim 1 of the present invention.

In FIG. 1, reference numeral 11 denotes a random number generator, numeral 12 denotes a public key generator, and numeral 13 denotes a semiconductor integrated circuit that is housed in a package (hereinafter, referred to as LSI). Numeral 14 denotes a controller that controls the random number generator 11 and the public key generator 12. Numeral 15 denotes a public key generation apparatus of user 1 as a source of public key distribution, including the semiconductor integrated circuit 13 and the controller 14.

Hereinafter, the operation of the public key generation apparatus according to the first embodiment will be described with reference to FIG. 1.

The random number generator 11 generates a random number ka as a secret key ka under the control of the controller 14. In this case, the secret key ka holds a relationship 0<ka<q, where an element in a finite group F for which multiplication is defined is g and an order that is a prime number of the element g is q. The controller 14 sets timing of the random number generation, and the seed and the initial value of the random number. For example, a microcomputer is employed as the controller 14.

The public key generator 12 generates a public key ya under the control of the controller 14. The public key ya is obtained from the secret key ka by the above-mentioned Formula 1. The generated public key ya is transmitted by the controller 14 to user 2 as a destination of public key distribution.

In this construction, when at least the random number generator 11 and the public key generator 12 are integrated in the LSI 13, it is quite difficult to divert or change the arithmetic of Formula 1 into a different cryptography. When the controller 14 is further integrated in the LSI 13, this effect is enhanced. Further, when the random number generator 11 generates a new random number ka after the generation of the public key ya, the value of the public key ya varies with each output. At this time, as is apparent from Formula 1, the public key ya is a function of the random number ka. Therefore, it is extremely difficult for anyone including the user 1 to divert or change the public key generation apparatus 15 for purposes other than the generation of the public key ya.

As described above, according to the first embodiment, the random number generator 11 and the public key generator 12 included in the public key generation apparatus 15 are integrated in one LSI 13. Therefore, this public key generator 15 uses the secret key ka in the LSI 13 only for the generation of the public key ya. Further, the arithmetic expression of Formula 1 for generating the public key ya, which is the main arithmetic in the apparatus 15, is not revealed to the outside. Consequently, it is possible to achieve a state where diversion or change of the main arithmetic of the apparatus 15 for purposes other than the generation of the public key ya is quite difficult, whereby resistance to illegal attacks to the public key generation apparatus 15 by the third parties can be made quite higher as compared to the conventional example of generating the secret key ka and the public key ya using the computational algorithm for which no safety measure is taken.

In this first embodiment, the description has been given of the case of obtaining the public key ya by Formula 1, while the public key ya can be obtained by the aforementioned Formula 5 using the elliptic curve cryptosystem.

Further, it is needless to say that the same effect can be obtained in any public key cryptosystem when a public key cryptosystem based on the discrete logarithm problem is utilized in the public key generation apparatus.

### Embodiment 2

A shared key generation apparatus according to a second embodiment, corresponding to claim 5 of the present invention will be described.

FIG. 2 is a block diagram illustrating a shared key generation apparatus according to the second embodiment. In FIG. 2, the same reference numerals as those in FIG. 1 denote the same or corresponding components. Numeral 21 denotes a shared key generator, numeral 22 denotes an LSI including the random number generator 11 and the shared key generator 21. Numeral 23 denotes a controller that controls the random number generator 11 and the shared key generator 21. Numeral 24 denotes a shared key generation apparatus for user 1 (source of shared key distribution), which generates a shared key Ka on the basis of a public key yb that is generated by user 2 (destination of shared key distribution) and a secret key ka that is generated by the random number generator 11.

Hereinafter, the operation of the shared key generation apparatus 24 according to the second embodiment will be described with reference to FIG. 2.

The random number generator 11 generates a random number ka under the control of the controller 23 and outputs the same as a secret key ka. In this case, the secret key ka holds a relationship 0<ka<q, where an element in a finite group F for which multiplication is defined is g, and an order that is a prime number of the element g is q. The controller 23 sets timing of generating of the random number ka, and the seed and the initial value of the random number ka. For example, a microcomputer is employed for the controller 23. Further, the controller 23 obtains, from the user 2 as the destination of shared key distribution, a public key yb for the user 2, which is expressed by Formula 2. The shared key generator 21 generates a shared key Ka under the control of the controller 23. The shared key Ka is obtained by Formula 3 on the basis of the secret key ka for the user 1 and the public key yb for the user 2. The generated shared key Ka is used, for example, by the controller 23 as a key for the secret key cryptosystem. This key is utilized for encrypted transmission using the common shared key Ka between the user 1 and the user 2.

In the above-mentioned structure, when at least the random number generator 11 and the shared key generator 21 are integrated in the LSI 22, it is quite difficult to divert or change the arithmetic of Formula 3 into other cryptography. When the controller 23 is further integrated in the LSI 22, this effect is enhanced. In addition, when the random number generator 11 generates a new random number ka after the generation of the shared key Ka, the value of the shared key Ka varies with each output. At this time, as is apparent from Formula 3, the shared key Ka is a function of the random number ka. Therefore, it is quite difficult for anyone including the user 1 to divert or change this shared key generation apparatus 24 for purposes other than the generation of the shared key Ka.

As described above, according to the second embodiment, the random number generator 11 and the shared key generator 21 included in the shared key generation apparatus 24 are integrated in one LSI 22. Therefore, in this shared key generation apparatus 24, the secret key ka is used in the LSI 22 only for the generation of the shared key Ka. Further, the arithmetic of Formula 3 for generating the shared key Ka that is the main arithmetic of the apparatus 24 is not revealed to the outside. Consequently, the diversion or change of the main arithmetic in this apparatus 24 for purposes other than the generation of the shared key Ka can be made quite difficult. Accordingly, the resistance to illegal attacks to the shared key generation apparatus 24 by the third parties can be made quite higher as compared to the conventional example of generating the secret key ka and the shared key Ka using the computational algorithm for which no safety measures are not taken.

In this second embodiment, the description has been given of the case of obtaining the shared key Ka by Formula 3, while the same effect is obtained by calculating the shared key Ka by the aforementioned Formula 7 using the elliptic curve cryptosystem.

In addition, it goes without saying that the same effect can be obtained in any public key cryptosystem, when a public key cryptosystem based on the discrete logarithm problem is employed in the shared key generation apparatus.

### Embodiment 3

A key exchange apparatus according to a third embodiment, corresponding to claim 9 of the present invention will be described.

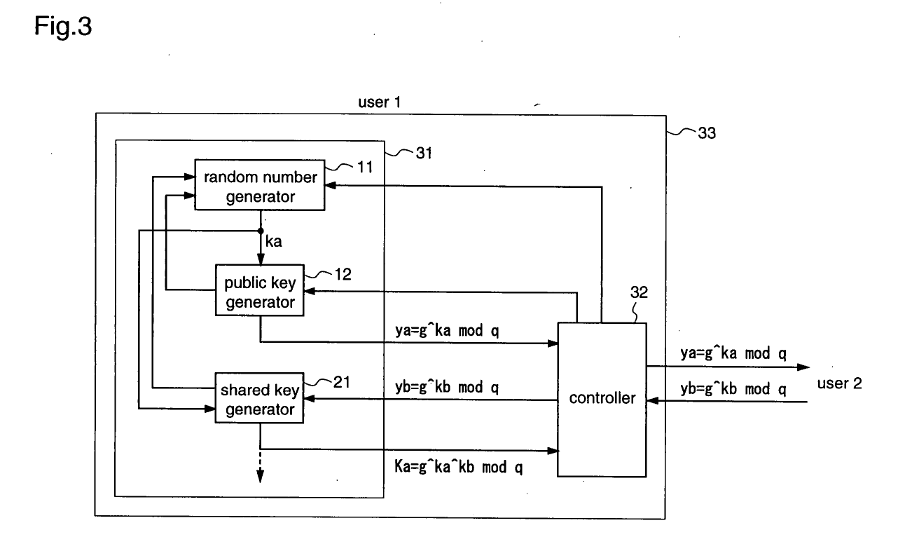

FIG. 3 is a block diagram illustrating a key exchange apparatus according to the third embodiment.

In FIG. 3, the same reference numerals as those in FIGS. 1 and 2 denote the same or corresponding components. Numeral 31 denotes an LSI including the random number generator 11, the public key generator 12, and the shared key generator 21. Numeral 32 denotes a controller that controls the random number generator 11, the public key generator 12, and the shared key generator 21. Numeral 33 denotes a key exchange apparatus for the user 1 as a distribution source of the shared key Ka, which is generated on the basis of the public key yb generated by the user 2 (a source of public key distribution and a destination of shared key distribution), and the secret key ka generated by the random number generator 11.

Hereinafter, the operation of the key exchange apparatus 33 according to the third embodiment.

The random number generator 11 generates a random number ka under the control of the controller 32, and outputs the generated random number as a secret key ka. In this case, the secret key ka holds a relationship 0<ka<q, where an element in a finite group F for which multiplication is defined is g, and the order of a prime number of the element g is q. The controller 32 set timing of generation of the random number ka, and the seed and the initial value of the random number ka. For example, a microcomputer is employed as the controller 32. The public key generator 12 generates a public key ya under the control of the controller 32. The public key ya is calculated by Formula 1. The generated public key ya is transmitted to the user 2 by the controller 32.

Further, the controller 32 obtains, from the user 2, the public key yb of the user 2, which is expressed by Formula 2. The shared key generator 21 generates a shared key Ka under the control of the controller 32. The shared key Ka is obtained by Formula 3 using the secret key ka and the public key yb obtained from the user 2. The generated shared key Ka is for example employed by the controller 32 as a key for the secret key cryptosystem, and utilized for encrypted transmission between the user 1 and the user 2.

In this construction, when at least the random number generator 11, the public key generator 12, and the shared key generator 21 are integrated in the LSI 31, it is quite difficult to divert or change the arithmetic of Formulae 1 and 3 for other cryptography. When the controller 32 is further integrated in the LSI 31, this effect is enhanced. In addition, when the random number generator 11 generates a new random number ka after the generation of the public key ya and the shared key Ka, the public key ya and the shared key Ka have values that vary with each output. At this time, as is apparent from Formulae 1 and 3, the public key ya and the shared key Ka are functions of the random number ka. Therefore, it is quite difficult for anyone including the user 1 to divert or change this key exchange apparatus 33 for purposes other than the generation of the public key ya and the shared key Ka, and the exchange of the secret keys ya and yb between the user 1 and the user 2.

As described above, according to the third embodiment, the random number generator 11, the public key generator 12, and the shared key generator 21 included in the key exchange apparatus 33 are integrated in one LSI 31. Therefore, the key exchange apparatus 33 utilizes the secret key ka only for the purpose of generation of the public key ya and the shared key Ka in the LSI 31. Accordingly, it is possible to prevent the arithmetic operations of Formula 1 for generating the public key ya and Formula 3 for generating the shared key Ka as the main arithmetic of the apparatus 33 from revealing to the outside. Consequently, the diversion or change of the main arithmetic in this apparatus 33 for the purposes other than the generation of the public key ya and the shared key Ka, and further the diversion or change of the apparatus 33 for cryptography other than the key exchange can be made quite difficult. Accordingly, the resistance to illegal attacks to the key exchange apparatus 33 by the third parties can be made extremely higher as compared to the conventional example of generating the secret key ka, the public key ya, and the shared key Ka using the computational algorithm for which no safety measures are taken.

In this third embodiment, the description has been given of the case of calculating the public key ya and the shared Ka by Formulae 1 and 3, while the public key ya and the shared key Ka may be obtained by the aforementioned Formula 5 and 7 using the elliptic curve cryptosystem.

Further, it is needless to say that the same effect is obtained in any public key cryptosystem as long as a public key cryptosystem based on the discrete logarithm problem is used in this key exchange apparatus.

Here, it goes without saying that the key exchange between the user 1 and the user 2 can be performed quite safely when the user 2 utilizes a key exchange apparatus having the same structure as the key exchange apparatus 33 according to the third embodiment.

### Embodiment 4

A key exchange apparatus according to a fourth embodiment, corresponding to claim 13 of the present invention will be described.

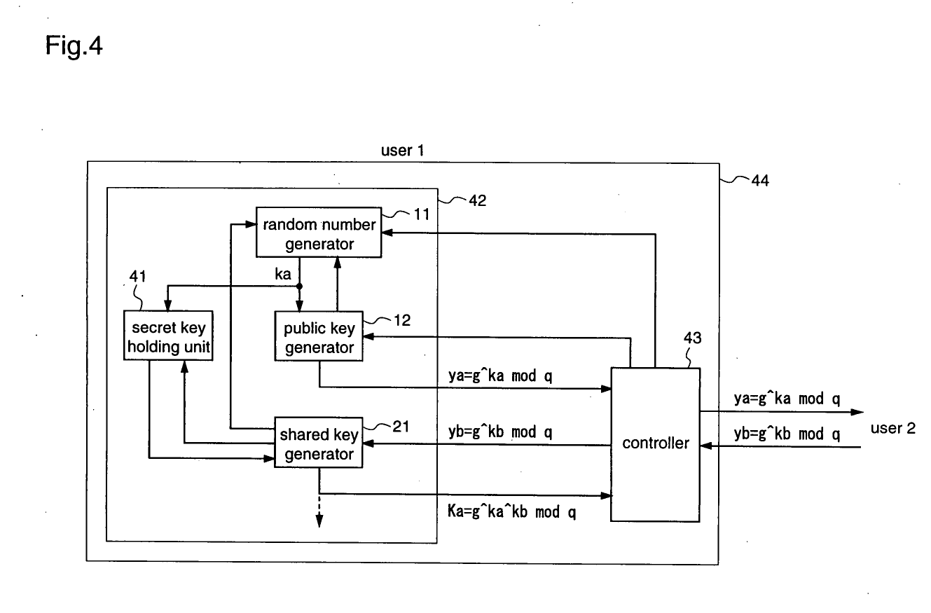

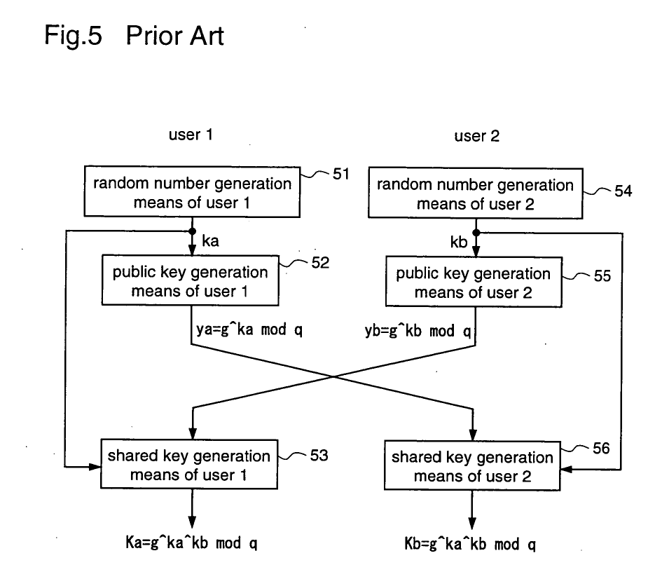

FIG. 4 is a block diagram illustrating a key exchange apparatus according to the fourth embodiment.

In FIG. 4, the same reference numerals as those in FIGS. 1 and 2 denote the same or corresponding components. Numeral 41 denotes a secret key holding unit that temporarily holds the secret key ka generated by the random number generator 11. Numeral 42 denotes an LSI including the random number generator 11, the public key generator 12, the shared key generator 21, and the secret key holding unit 41. Numeral 43 denotes a controller that controls the random number generator 11, the public key generator 12, and the shared key generator 21. Numeral 44 denotes a key exchange apparatus for the user 1 as a distribution source of the shared key Ka that is generated on the basis of the public key yb generated by the user 2 (a source of public key distribution and a destination of shared key distribution), and the secret key ka generated by the random number generator 11.

Hereinafter, the operation of the key exchange apparatus 44 according to the fourth embodiment will be described with reference to FIG. 4.

The random number generator 11 generates a random number ka under the control of the controller 43, and outputs the random number ka as a secret key ka. In this case, the secret key ka holds a relationship 0<ka<q, where an element in a finite group F for which multiplication is defined is g and the order as a prime number of the element g is q. The controller 43 sets timing of generation of the random number ka, or the seed and the initial value of the random number ka. For example, a microcomputer is employed as the controller 43. The secret key holding unit 41 temporarily holds the secret key ka. The public key generator 12 generates a public key ya under the control of the controller 43. The public key ya is calculated by Formula 1. The generated public key ya is transmitted to the user 2 by the controller 43.

Further, the controller 43 obtains, from the user 2, the public key yb of the user 2, which is expressed by Formula 2. The shared key generator 21 generates a shared key Ka under the control of the controller 43. The shared key Ka is calculated by Formula 3 on the basis of the secret key ka that is held in the secret key holding unit 41 and the public key yb that is obtained from the user 2. The generated shared key Ka is used, for example, by the controller 43 as a key for the secret key cryptosystem, and utilized at encrypted transmission between the user 1 and the user 2.

In the above-mentioned structure, when at least the random number generator 11, the public key generator 12, the shared key generator 21, and the secret key holding unit 41 are integrated in the LSI 42, it is quite difficult to divert or change the arithmetic of Formulae 1 and 3 for other cryptography. When the controller 43 is further integrated in the LSI 42, the effect is enhanced.

In addition, when the random number generator 11 generates a new random number ka after the generation of the public key ya, the value of the public key ya varies with each output. At this time, as is apparent from Formula 1, the public key ya is a function of the random number ka. Then, in this fourth embodiment, even when the random number generator 11 generates a new random number ka before the shared key generator 21 generates the shared key Ka, the shared key generator 21 can always generate a proper shared key Ka because the secret key holding unit 41 holds the secret key ka that is used in the generation of the shared key Ka.

Further, when the random number generator 11 generates a new random number ka after the shared key generation unit 21 generates the shared key Ka, and then the secret key holding unit 41 holds the generated new random number ka, the value of the shared key Ka varies with each output. At this time, as is apparent from Formula 3, the shared key Ka is a function of the random number ka.

Accordingly, it is quite difficult for anyone including the user 1 to divert or change the key exchange apparatus 44 for purposes other than the generation of the public key ya and the shared key Ka and the key exchange of the secret keys ya and yb between the user 1 and the user 2.

Further, even when the public key ya and the shared key Ka that is outputted to outside the LSI 42 are observed, it is impossible to even infer the structures of the public key generator 12 and the shared key generator 21 because the values of the public key and the shared key are functions of the random number ka.

As described above, according to the fourth embodiment, the random number generator 11, the public key generator 12, the shared key generator 21, and the secret key holding unit 42 included in the key exchange apparatus 44 are integrated in one LSI 42. Therefore, in this key exchange apparatus 44, the secret key ka is used in the LSI 42 only for the generation of the public key ya and the shared key Ka. Further, the arithmetic of Formula 1 for generating the public key ya and the arithmetic of Formula 3 for generating the shared key Ka, which is the main arithmetic of the apparatus 44, is not revealed to the outside. Consequently, it is possible to make quite difficult the diversion or change of the main arithmetic of the apparatus 44 for the purposes other than the generation of the public key ya and the shared key Ka, and further the diversion or change of the apparatus 44 for cryptography other than the key exchange. Accordingly, the resistance to illegal attack to the key exchange apparatus 44 by the third parties can be made quite higher as compared to the conventional example of generating the secret key ka, the shared key ya, and the shared key Ka using the computational algorithm to which no safety measures are taken.

In addition, in the fourth embodiment, the key exchange apparatus 44 includes the secret key holding unit 41 that temporarily holds the random number ka generated by the random number generator 11. Therefore, even when the random number generator 11 generates a new random number ka before the shared key generator 21 generates a shared key Ka, the shared key generator 21 can always generate a proper shared key Ka.

In this fourth embodiment, the description has been given of the case of calculating the public key ya and the shared key Ka by Formulae 1 and 3, while the same effect is obtained by calculating the public key ya and the shared key Ka by the aforementioned Formulae 5 and 7 using the elliptic curve cryptosystem.

It is needless to say that the same effect is obtained in any public key cryptosystem when using a public key cryptosystem based on the discrete logarithm problem in this key exchange apparatus.

Here, when the user 2 utilizes a key exchange apparatus having the same structure as the key exchange apparatus 44 according to the fourth embodiment, it is possible to perform the key exchange between the user 1 and the user 2 quite safely.

1. A public key generation apparatus including:
a random number generator for generating a random number ka that holds a relationship 0<ka<q, where an element in a finite group F for which multiplication is defined is g and an order that is a prime number of the element g is q; and
a public key generator for calculating a public key ya in the finite group F from the random number ka, the element g, and the prime number q,
at least said random number generator and said public key generator being formed on one semiconductor integrated circuit, and
a controller of a first user as a distribution source of the public key controlling the random number generator and the public key generator for obtaining the public key ya, and transmitting the obtained public key ya to a second user as a distribution destination of the public key.

2. The public key generation apparatus of claim 1 wherein
said public key generator calculates the public key ya in the finite group F by a formula: ya=g\hat{ }ka mod q, using the random number ka, the element g, and the prime number q.

3. The public key generation apparatus of claim 1 wherein
when the finite group F is an elliptic curve E(F) in a finite field, and an element of the elliptic curve E(F) is G,
said public key generator calculates the public key ya on the elliptic curve E(F) by a formula: ya=kaG mod q, using the random number ka, the element G, and the prime number q.

4. The public key generation apparatus of claim 1 wherein
said random number generator generates a new random number ka after the calculation of the public key ya is completed.

5. A shared key generation apparatus including:
a random number generator for generating a random number ka that holds a relationship 0<ka<q, where an element in a finite group F for which multiplication is defined is g and an order that is a prime number of the element g is q; and
a shared key generator for calculating a shared key Ka in the finite group F from a public key yb that is generated from a random number kb which holds a relationship 0<kb<q and is generated by a second user as a distribution destination of the shared key, and the random number ka,
at least said random number generator and said shared key generator being formed on one semiconductor integrated circuit, and
a controller of a first user as a distribution source of the shared key obtaining the public key yb from the second user as the shared key distribution destination, and controlling the random number generator and the shared key generator for deriving the shared key Ka.

6. The shared key generation apparatus of claim 5 wherein
said shared key generator calculate the shared key Ka in the finite group F by a formula: Ka=yb\hat{ }ka mod q, using the public key yb=g\hat{ }kb mod q which is generated by the second user as the shared key distribution destination and the random number ka.

7. The shared key generation apparatus of claim 5 wherein
when the finite group F is an elliptic curve E(F) in a finite field and an element of the elliptic curve E(F) is G,
said shared key generator calculates the shared key Ka on the elliptic curve E(F) by a formula: Ka=kayb mod q, using the public key yb=kbG mod q which is generated on the elliptic curve E(F) from the random number kb by the second user as the shared key distribution destination, and the random number k.

8. The shared key generation apparatus of claim 5 wherein
said random number generator generates a new random number ka after the calculation of the shared key Ka is completed.

9. A key exchange apparatus including:
a random number generator for generating a random number ka that holds a relationship 0<ka<q, where an element in a finite group F for which multiplication is defined is g and an order that is a prime number of the element g is q;
a public key generator for calculating a public key ya in the finite group F from the random number ka, the element g, and the prime number q; and
a shared key generator for calculating a shared key Ka in the finite group F on the basis of the public key yb generated from a random number kb which holds a relationship 0<kb<q and is generated by a second user as a distribution destination of the shared key, and the random number ka,
at least said random number generator, said public key generator, and said shared key generator being formed on one semiconductor integrated circuit, and
a controller of a first user as a distribution source of the shared key controlling the random number generator and the public key generator for obtaining the public key yb, and controlling the shared key generation unit for deriving the shared key ka.

10. The key exchange apparatus of claim 9 wherein
said public key generator calculates the public key ya in the finite group F by a formula: ya=g\hat{ }ka mod q, using the random number ka, the element g, and the prime number q, and said shared key generator calculates the shared key Ka in the finite group F by a formula: Ka=yb\hat{ }ka mod q, using the public key yb=g\hat{ }kb mod q which is generated in the finite group F by the second user as the shared key distribution destination using the random number kb, and the random number ka.

11. The key exchange apparatus of claim 9 wherein
when the finite group F is an elliptic curve E(F) in a finite field, and an element of the elliptic curve E(F) is G,
said public key generator calculates the public key ya on the elliptic curve E(F) by a formula: ya=kaG mod q, using the random number ka, the element G, and the prime number q, and p1 said shared key generator calculates the shared key Ka on the elliptic curve E(F) by a formula: Ka=kayb mod q, using the public key yb=kbG mod q generated from the random number kb on the elliptic curve E(F) by the second user as the shared key distribution destination, and the random number ka.

12. The key exchange apparatus of claim 9 wherein
the random number generator generates a new random number ka after the calculation of the public key ya and the calculation of the shared key Ka are both completed.

13. A key exchange apparatus including:
a random number generator for generating a random number ka that holds a relationship 0<ka<q, where an element in a finite group F for which multiplication is defined is g and an order that is a prime number of the element g is q;
a secret key holding unit for temporarily holding the random number ka;
a public key generator for calculating a public key ya in the finite group F from the random number ka, the element g, and the prime number q; and
a shared key generator for calculating a shared key Ka in the finite group F using a public key yb generated from a random number kb which holds a relationship 0<kb<q and is generated by a second user as a destination distribution of the shared key, and the random number ka that is held by the secret key holding unit,
at least said random number generator, said secret key holding unit, said public key generator, and the shared key generator being formed on one semiconductor integrated circuit,
a controller of a first user as a distribution source of the shared key controlling the random number generator and the public key generator for obtaining the public key ya, and transmitting the obtained public key ya to a second user as a distribution destination of the shared key, and
said controller obtaining the public key yb from the second user as the shared key distribution destination, and controlling the shared key generator for deriving the shared key Ka.

14. The key exchange apparatus of claim 13 wherein
the public key generator calculates the public key ya in the finite group F using the random number ka, the element g, and the prime number q by a formula: ya=g\hat{ }ka mod q, and
the shared key generator calculates the shared key Ka in the finite group F by a formula: Ka=yb\hat{ }ka mod q, using the public key yb=g\hat{ }kb mod q that is generated in the finite group F from the random number kb by the second user as the shared key distribution destination, and the random number ka that is held in the secret key holding unit.

15. The key exchange apparatus of claim 13 wherein
when the finite group F is an elliptic curve E(F) in a finite field, and an element on the elliptic curve E(F) is G,
the public key generator calculates the public key ya on the elliptic curve E(F) using the random number ka, the element G, and the prime number q by a formula: ya=kaG mod q, and
the shared key generator calculates the shared key Ka on the elliptic curve E(F) by a formula: Ka=Kayb mod q, using the public key yb=kbG mod q that is generated from the random number kb on the elliptic curve E(F) by the second user as the shared key distribution destination, and the random number ka that is held in the secret key holding unit.

16. The key exchange apparatus of claim 13 wherein
the random number generator generates a new random number ka after the calculation of the public key ya is completed, and
the secret key holding unit holds the new random number ka generated by the random number generator.

17. The key exchange apparatus of claim 13 wherein
the random number generator generates a new random number ka after the calculation of the shared key Ka is completed, and
the secret key holding unit holds the new random number ka generated by the random number generator.

18. A key exchanging method that employs the key exchange apparatus of claim 9, thereby exchanging the public keys that are generated by a first user and a second user that intend to exchange the public keys, respectively, to generate a shared key by the first user and the second user on the basis of the exchanged public key, respectively.

19. A key exchanging method that employs the key exchange apparatus of claim 13, thereby exchanging the public keys that are generated by a first user and a second user that intend to exchange the public keys, respectively, to generate a shared key by the first user and the second user on the basis of the exchanged public key, respectively.
